(19) United States
(12) Patent Application Publication
(10) Pub. No.: US 2012/0189465 A1
(43) Pub. Date: Jul. 26, 2012

(54) HIGH PRESSURE FUEL PUMP PISTON ASSEMBLY

(75) Inventor: Christofer J. Palumbo, Elmwood Park, IL (US)

(73) Assignee: International Engine Intellectual Property Company , LLC, Warrenville, IL (US)

(21) Appl. No.: 13/011,594

(22) Filed: Jan. 21, 2011

(51) Int. Cl. F04B 49/00; F16J 1/00

(52) U.S. Cl. 417/53; 92/172

(57) ABSTRACT

A piston assembly for a fuel pump comprises a first piston sub-assembly and a second piston sub-assembly. The first piston sub-assembly comprises a first piston portion, a first check ball connected to a first spring and a first O-ring. The first check ball forms a fluid tight seal against the first piston portion when the first spring is uncompressed. The first check ball allows fluid flow relative to the first piston portion when the first spring is compressed. The first O-ring has a front side and a back side. The first O-ring forms a fluid tight seal relative to the first piston portion. The second piston sub-assembly comprises a second piston portion, a second check ball connected to a second spring, and a second O-ring. The second check ball forms a fluid tight seal against the second piston portion when the second spring is uncompressed. The second check ball allows fluid flow relative to the second piston portion when the second spring is compressed. The second O-ring has a front side and a back side. The second O-ring forms a fluid tight seal relative to the second piston portion. The fluid flow relative to the first piston portion allows fluid to contact the front side of the second O-ring and the back side of the first O-ring.

### TECHNICAL FIELD

The present patent relates to a high pressure fuel pump for an engine, and more particularly to piston-type high pressure fuel pump having a plurality of piston sub-assemblies with an O-ring and check valve controlling fuel flow between adjacent piston sub-assemblies to generate the required pressure as the piston reciprocates within the pump.

### BACKGROUND OF THE INVENTION

Many factors, including environmental responsibility efforts and modern environmental regulations on engine exhaust emissions have reduced the allowable acceptable levels of certain pollutants that enter the atmosphere following the combustion of fossil fuels. One factor that has been found to reduce engine emissions, as well as engine performance, is the use of very high pressure fuel systems having fuel pressures of approximately 3000 psi. Very high pressure fuel systems improve fuel atomization as pressure increases, and the improved atomization results in more uniform and complete combustion, reducing engine emissions and increasing engine power output.

One type of very high pressure fuel system is a common rail fuel system that features a fuel accumulator, or common rail, that contains very highly pressurized fuel that is then delivered to fuel injectors of the engine. The common rail fuel system typically features a lift pump, or low pressure pump, that draws fuel from a fuel tank, and a high pressure fuel pump that obtains fuel that has passed through the lift pump and pressurizes the fuel to a predetermined pressure. The fuel that has passed through the high pressure fuel pump is delivered to the fuel accumulator for delivery to the fuel injectors.

Existing high pressure fuel pumps are often less durable than desired, and are expensive to produce. In order to address durability of high pressure fuel pumps, many manufacturing controls have been required, such as the cleanliness of the manufacturing facility, higher quality materials, complicated manufacturing processes, and close tolerances of components. However, the close tolerances may result in the high pressure fuel pump being damaged by debris from the fuel, or from manufacturing debris.

Additionally, the use of seals, particularly O-rings, are not always effective at pressures of about 3000 psi. Many standard O-rings may be damaged by pressures over 800 psi. The fact that the pressure within the high pressure fuel pump exceeds the pressure that a standard O-ring may withstand results in reduced durability of the high pressure fuel pump, or the need for more costly seals within the high pressure fuel pump.

Therefore a need exists for a high pressure fuel pump that is capable of developing fuel pressures of about at least 3000 psi, and utilizes standard O-rings without subjecting the O-ring to pressures in excess of what the standard O-ring may withstand.

### SUMMARY OF THE INVENTION

According to one embodiment, a piston assembly for a fuel pump comprises a first piston sub-assembly and second piston sub-assembly. The first piston sub-assembly comprises a first piston portion, a first check ball connected to a first spring, and a first O-ring. The first check ball forms a fluid seal against the first piston portion when the first spring is uncompressed. The first check ball allows fluid flow relative to the first piston portion when the first spring is compressed. The first O-ring has a front side and a back side. The first O-ring forms a fluid seal relative to the first piston portion. The second piston sub-assembly is disposed in series with the first piston sub-assembly and comprises a second piston portion, a second check ball connected to a second spring, and a second O-ring. The second check ball forms a fluid seal against the second piston portion when the second spring is uncompressed. The second check ball allows fluid flow relative to the second piston portion when the second spring is compressed. The second O-ring has a front side and a back side. The second O-ring forms a fluid seal relative to the second piston portion. The fluid flow relative to the first piston portion causes fluid to contact the front side of the second O-ring and the back side of the first O-ring.

According to another embodiment, a piston sub-assembly for a fuel pump piston assembly comprises a piston portion, a check ball connected to a spring, and an O-ring. The check ball forms a fluid seal against the piston portion when the first spring is uncompressed. The check ball allows fluid flow relative to the piston portion when the first spring is compressed. The O-ring has a front side and a back side. The O-ring forms a fluid seal relative to the piston portion.

According to one process, a method of operating a fuel pump with a piston sub-assembly is provided. Pressure is generated at a first piston sub-assembly comprising a first O-ring that has a front side and a back side, a first piston portion, and a first fluid flow control feature. The first fluid flow control feature opens at a predetermined pressure. Fluid is allowed to flow relative to the first piston portion through the first fluid flow control feature once the predetermined pressure is obtained. Pressure is generated at a second piston sub-assembly that comprises a second O-ring that has a front side and a back side, a second piston portion, and a second fluid flow control feature. The pressure at the second piston sub-assembly is generated by the fluid that has passed through the first fluid flow control feature.

### BRIEF DESCRIPTION OF THE DRAWINGS

FIG. 1 is a schematic partial sectional view of a piston assembly for a high pressure fuel pump according to one embodiment.

FIG. 2 is a schematic partial view of the piston assembly of FIG. 1 depicting fuel in a first location of the piston assembly.

FIG. 3 is a schematic partial view of the piston assembly of FIG. 1 depicting fuel in a second location of the piston assembly.

FIG. 4 is a schematic partial view of the piston assembly of FIG. 1 depicting fuel in a third location of the piston assembly.

FIG. 5 is a schematic partial view of the piston assembly of FIG. 1 depicting fuel in a fourth location of the piston assembly.

### DETAILED DESCRIPTION

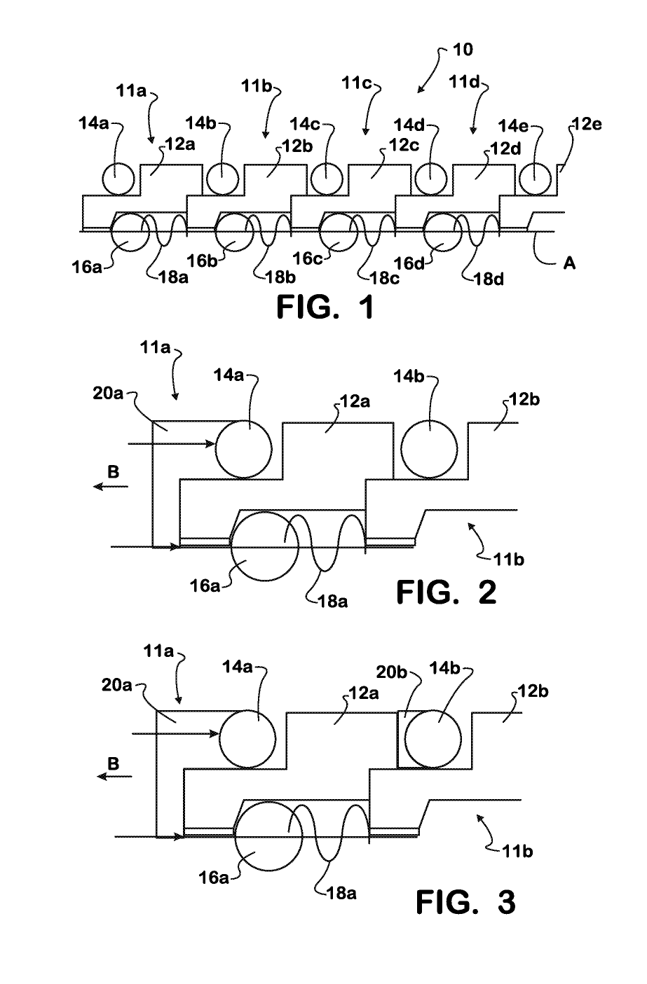

FIG. 1 depicts a piston assembly 10 for a high pressure fuel pump. The piston assembly 10 comprises a plurality of piston sub-assemblies 11a-11d. Each piston subassembly 11a-11d comprises a piston portion 12a-12e, an O-ring 14a-14e, a check ball 16a-16d, and a spring 18a-18d connected to the respective check ball 16a-16d. Each of the piston sub-assemblies 11a-11d are generally identical, and function in a generally identical manner. Each of the O-rings 14a-14e form a fluid seal against a cylinder wall (not shown) in which the piston assembly 10 reciprocates within the high pressure fuel pump, restricting or preventing the flow of fuel past the O-ring, and may be a generally fluid tight seal.

The piston portions 12a-12e are attached to each other in order to maintain a predefined arrangement between each of the piston portions 12a-12e. The predefined arrangement of the piston portions 12a-12e allows fuel to flow between the check ball 16a of one piston subassembly, such as a first piston sub-assembly 11a and the O-ring 14b of a serially disposed adjacent piston sub-assembly, such as a second piston sub-assembly 11b. It is contemplated that a ring dowel may be utilized to secure the first piston portion 12a to the second piston portion 12b. The successive piston portions 12b-12e would additionally be interconnected as the first piston portion 12a and the second piston portion 12b. The use of a ring dowel would require holes (not shown) to be placed within each of the piston portions 12a-12e to support the ring dowel. Alternatively, a snap-ring may be utilized to secure adjacent piston portions 12a-12e. A snap-ring would require snap ring grooves (not shown) to be placed within each of the piston portions 12a-12e to receive the snap-rings.

The O-rings 14a-14e form fluid seals that generally prevent fuel from flowing between adjacent piston sub-assemblies, such as a first piston sub-assembly 11a and a second piston sub assembly 11b, near a periphery of the first piston sub-assembly 11a. The O-rings 14a-14e are standard O-rings capable of withstanding a pressure of up to about 800 psi.

The plurality of piston sub-assemblies 11a-11d additionally comprise a plurality of check balls 16a-16d and springs 18a-18d. The check ball 16a-16d of each piston sub-assembly 11a-11d is connected to the respective spring 18a-18d of each piston sub-assembly 11a-11d, such as a first check ball 16a is connected to a first spring 18a. The spring 18a-18d of one piston sub-assembly 11a-11d connects to a piston portion 12b-12e of an adjacent piston sub assembly 11b-11d. As shown in FIG. 1, it is contemplated that the O-rings 14a-14e are disposed at a radially outward position of the piston assembly 10 relative to the plurality of check balls 16a-16e and springs 18a-18d.

Turning now to FIGS. 2-5, the flow of fuel between the first piston sub-assembly 11a and the second piston sub-assembly 11b within the piston assembly 10 of a high pressure fuel pump is depicted. FIG. 2 shows fuel 20a being acted on by the first piston sub-assembly 11a. The piston portion 12a pushes against the fuel 20a as the piston assembly 10 moves in the direction of arrow B. The fuel 20a additionally contacts the O-ring 14a of the first piston sub-assembly 11a and the check ball 16a of the first piston sub-assembly 11a. As shown in FIG. 2, the pressure exerted on the check ball 16a is not sufficient to compress the spring 18a of the first piston sub-assembly 11a to allow fuel past the check ball 11a. Thus, when the spring 18a is not compressed, the check ball 16a forms a fluid seal with respect to the first piston portion 12a.

As shown in FIG. 3, the spring 18a of the first piston sub-assembly 11a has been compressed such that fuel 20a flows around the check ball 16a of the first piston sub-assembly 11a and enters the second piston sub-assembly 11b. The fuel 20b in the second piston sub-assembly 11b pushes against the piston portion 12b and the O-ring 14b, as well as the check ball 16b (not shown). The fuel 20b in the second piston sub-assembly 11b has yet to compress the spring 18b (not shown).

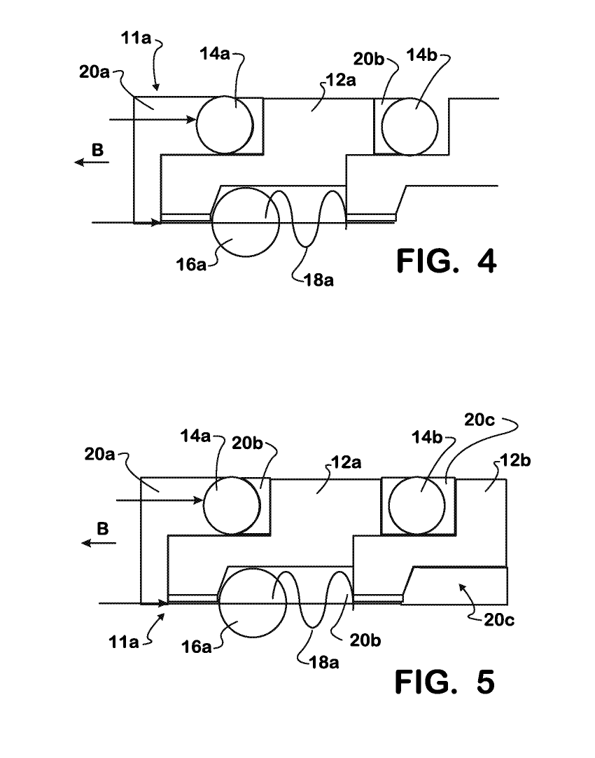

Turning to FIG. 4, the fuel 20b that entered the second piston sub-assembly 11b flows to a back side of the first O-ring 14a of the first piston sub-assembly 11a. That is, fuel 20a is located on a front side of the first O-ring 14a, while fuel 20b that has entered the second piston sub-assembly 11b is located on a back side of the first O-ring 14a. Therefore, the pressure on the O-ring 14a is reduced, as the fuel 20b on the back side of the first O-ring 14a supports the first O-ring 14a. For instance, it is contemplated that the spring 18a of the first piston sub-assembly 11a is set to compress at 500 psi such that fuel 20b may flow past the first check ball 16a; therefore, the first O-ring 14a will experience a 500 psi load once fuel 20b from the second piston sub-assembly 11b contacts the back side of the first O-ring 14a. Therefore, if the first O-ring 14a can withstand an 800 psi load, the fact that a 500 psi load is being placed on the first O-ring 14a greatly reduces the failure rate of the first O-ring 14a while a 3000 psi pressure is being generated by the piston assembly 10.

Similar to FIG. 4, FIG. 5 shows that fuel 20c that flows past the second check ball 16b (not shown) flows to the back side of the second O-ring 14b of the second piston sub-assembly 11b. Therefore, the pressure on the second O-ring 14b will be the pressure when the second spring 18b (not shown) compresses to allow the second check ball 16b (not shown) to move to allow fuel to flow into the third piston sub-assembly 11c (not shown). This process continues until the desired fuel injection pressure is obtained at the first piston sub-assembly 11a. Allowing fuel from an adjacent piston sub-assembly to flow to the back side of a preceding O-ring allows the piston assembly 10 to generate a high fuel pressure of about 3000 psi, while limiting the pressure on any O-ring 14a-14e to the amount of pressure required to compress the spring 18a-18d of the following piston sub-assembly 11b-11d.

For instance, if a 3000 psi pressure is desired, the pressure of the fuel 20a on the front side of the first O-ring 14a will be 3000 psi, while the pressure of the fuel 20b on the back side of the first O-ring 14b will be 2500 psi, thus, allowing the first O-ring to experience a pressure of 500 psi. The number of piston sub-assemblies 11a-11d will vary based upon the desired fuel pressure and the properties of the springs 18a-18d utilized to control the check balls 16a-16d and the O-rings 14a-14e.

The fit between adjacent piston portions 12a-12e should be loose to allow fuel to flow between the adjacent piston sub-assemblies 11a-11d. If a tight fit is desired between the adjacent piston portions 12a-12e, it is contemplated that passages may be machined to allow fuel to bleed to a preceding piston sub-assembly.

It is additionally contemplated, according to an alternate embodiment, that instead of a check ball 16a-16d with an associated spring 18a-18d, a plunger having a one-way valve may be utilized to control fuel flow between adjacent piston sub-assemblies 11a-11d.

Additionally, it is contemplated, according to a further embodiment, that a second check ball may be utilized and associated with a second passage of each piston sub-assembly to control the flow of fuel between adjacent piston sub-assemblies 11a-11d when the piston is moving in the opposite direction of Arrow B. Such an arrangement will alleviate built-up pressure when the piston assembly 10 reverses direction.

The use of the common components for the piston sub-assemblies 11a-11d, as well as the avoidance of tight tolerances, reduces the complexity and cost of manufacturing the piston assembly 10. Additionally, durability of the piston assembly 10 is improved as the O-rings are replaceable, such that an O-ring of any one of the piston sub-assemblies may be replaced when it becomes worn, or at a predefined service interval, improving overall durability of the piston assembly 10.

It is additionally contemplated that the O-ring may be substituted with an alternate seal. For instance, an X-ring, a square ring, an elastomeric piston seal, or a U-cup may be used in place of an O-ring 14a-14e. It is also contemplated that a combination of O-rings and alternate seals may be utilized, where some of the O-rings 14a-14e are replaced by the alternate seals. It is further contemplated that an alternate seal may be provided proximate each O-ring 14a-14e to form a backup seal and wear sleeve. The alternative seals mat reduce the number of piston sub-assemblies 11a-11d required, which in some situations may improve the cost and durability of the pump.

What is claimed is:

1. A piston assembly for a fuel pump, the piston assembly comprising:
a first piston sub-assembly comprising a first piston portion, a first check ball connected to a first spring, the first check ball forming a fluid seal against the first piston portion when the first spring is uncompressed, and the first check ball allowing fluid flow relative to the first piston portion when the first spring is compressed, and a first O-ring having a front side and a back side, the first O-ring forming a fluid seal relative to the first piston portion; and
a second piston sub-assembly disposed in series with the first piston sub-assembly, the second piston sub-assembly comprising a second piston portion, a second check ball connected to a second spring, the second check ball forming a fluid seal against the second piston portion when the second spring is uncompressed, and the second check ball allowing fluid flow relative to the second piston portion when the second spring is compressed, and a second O-ring having a front side and a back side, the second O-ring forming a fluid seal relative to the second piston portion, wherein the fluid flow relative to the first piston portion causes fluid to contact the front side of the second O-ring and the back side of the first O-ring.

2. The piston assembly for a fuel pump of claim 1, wherein the first spring compresses at a pressure of about 500 psi.

3. The piston assembly for a fuel pump of claim 1, wherein the first spring contacts the second piston sub-assembly.

4. The piston assembly for a fuel pump of claim 1, wherein the fluid flow relative to the second piston portion allows fluid to contact the back side of the first O-ring.

5. The piston assembly for a fuel pump of claim 1, wherein the first piston portion connects to the second piston portion.

6. The piston assembly for a fuel pump of claim 1, wherein the first O-ring has a pressure rating of about 800 psi.

7. The piston assembly for a fuel pump of claim 1, wherein the first O-ring is disposed radially outward of the first check ball.

8. The piston assembly for a fuel pump of claim 1, wherein the front side of the first O-ring is disposed in fluid communication with the first check ball.

9. A piston sub-assembly for a fuel pump piston assembly comprising:
a piston portion;
a check ball connected to a spring, the check ball forming a fluid seal against the piston portion when the first spring is uncompressed, and the check ball allowing fluid flow relative to the piston portion when the first spring is compressed; and
an O-ring having a front side and a back side, the O-ring forming a fluid seal relative to the piston portion.

10. The piston sub-assembly for a fuel pump piston assembly of claim 9, wherein the spring compresses at a pressure of about 500 psi.

11. The piston sub-assembly for a fuel pump piston assembly of claim 9, wherein fluid flow relative to the first piston portion allows fluid to contact the back side of the O-ring.

12. The piston sub-assembly for a fuel pump piston assembly of claim 9, wherein the O-ring has a pressure rating of about 800 psi.

13. A method of operating a fuel pump with a piston sub-assembly comprising:
generating pressure at a first piston sub-assembly comprising a first seal having a front side and a back side, a first piston portion, and a first fluid flow control feature;
opening the first fluid flow control feature at a predetermined pressure;
allowing fluid to flow relative to the first piston portion through the first fluid flow control feature once the predetermined pressure is obtained; and
generating pressure at a second piston sub-assembly comprising a second seal having a front side and a back side, a second piston portion, and a second fluid flow control feature, the pressure at the second piston sub-assembly being generated by the fluid that has passed through the first fluid flow control feature.

14. The method of operating a fuel pump with a piston sub-assembly of claim 13, wherein the first fluid flow control feature comprises a ball valve connected to a spring.

15. The method of operating a fuel pump with a piston sub-assembly of claim 13, wherein the first fluid flow control feature comprises a plunger with a one way valve.

16. The method of operating a fuel pump with a piston sub-assembly of claim 13, the first seal comprises an O-ring.

17. The method of operating a fuel pump with a piston sub-assembly of claim 13, wherein the fluid that has passed through the first fluid control feature contacts the back side of the first seal.

18. The method of operating a fuel pump with a piston sub-assembly of claim 13, wherein the fluid that has passed through the first fluid control feature contacts the front side of the second seal.

19. The method of operating a fuel pump with a piston sub-assembly of claim 13, wherein the predetermined pressure is about 500 psi.

20. The method of operating a fuel pump with a piston sub-assembly of claim 13, wherein the first piston portion is connected to the second piston portion to allow fluid to flow between the first piston portion and the second piston portion when the fluid passes through the first fluid control feature.
